(19) United States
(12) Patent Application Publication
(10) Pub. No.: US 2013/0230128 A1
(43) Pub. Date: Sep. 5, 2013

(54) Communication Method for Estimating Doppler Spread

(71) Applicants: Yuh-Ren Tsai, Hsinchu City (TW); Chia-Hung Tsai, Hsinchu City (TW); Kai-Jie Yang, Hsinchu City (TW); Chin-Liang Wang, Hsinchu City (TW)

(72) Inventors: Yuh-Ren Tsai, Hsinchu City (TW); Chia-Hung Tsai, Hsinchu City (TW); Kai-Jie Yang, Hsinchu City (TW); Chin-Liang Wang, Hsinchu City (TW)

(73) Assignee: NATIONAL TSING HUA UNIVERSITY, Hsin Chu City (TW)

(21) Appl. No.: 13/602,799

(22) Filed: Sep. 4, 2012

(30) Foreign Application Priority Data
Mar. 5, 2012 (TW) 101107365

(51) Int. Cl. H04L 27/06

(52) U.S. Cl. 375/341; 375/340

(57) ABSTRACT

A communication method for estimating Doppler spread includes the following steps: transmitting a preamble signal to a receiver from a transmitter of a transmission terminal. The preamble signal is received by the receiver; followed by dividing the received samples in the preamble signal into a plurality of sets of samples. The plurality of sets of samples are introduced into a Doppler spread estimation algorithm to estimate Doppler spread.

### FIELD OF THE INVENTION

The present invention relates to Doppler spread estimation, and more particularly to a communication method for estimating Doppler spread which can effectively reduce the computational complexity.

### BACKGROUND OF THE INVENTION

Orthogonal frequency division multiplexing (OFDM) has been implemented in many practical wireless communication systems. Inter-symbol interference is eliminated almost completely by inserting a guard interval, e.g. cyclic prefix (CP), whose length is equal to or greater than the maximum delay time of the channel, into the beginning of each transmitted OFDM symbol. Furthermore, in time-invariant channels, the frequency selectivity due to multipath can be mitigated by using a simple one-tap equalizer. This benefit allows for high data rates and has resulted in the selection of OFDM as a standard for digital audio broadcasting (DAB), digital video broadcasting (DVB), IEEE 802.11, 802.16, and 3GPP LTE (3rd generation partnership project long term evolution).

In mobile (time-variant) channels, however, it requires many adaptive strategies for OFDM systems to accommodate time-varying effects and retain acceptable performance. The maximum Doppler spread, reflecting the time selectivity of a channel, then becomes an important parameter which helps adaptive schemes do effective adjustment, e.g. the filter length for channel estimation/tracking, the rate of resource re-allocation, etc. As a channel's time-varying effect becomes too selective to be ignored in an OFDM symbol, the knowledge of the maximum Doppler spread also facilitates interference cancellation algorithms to mitigate inter-carrier interference (ICI).

In the last decade, several Doppler spread estimation approaches have been proposed for OFDM systems. In one part of the existing conventional techniques, correlations between frequency domain signals from different received OFDM symbols are used for Doppler estimation. One of the drawbacks of the frequency-domain-based estimators is the performance degradation caused by inter-carrier interference (ICI) as the Doppler frequency increases. To conquer this problem, a conventional technique, based on the autocorrelation value between samples of frequency domain signals, then takes the effect of ICI into account. Another part of the conventional techniques utilizes correlations between time domain OFDM signals to estimate Doppler spread. In one conventional technique, the correlation of CP of OFDM symbols is used to estimate the Doppler spread. Another conventional technique exploits the auto-covariance of the received signal power in time domain to improve the estimation accuracy, especially in low signal-to-noise ratio (SNR) regions. It is noted that most of the existing conventional techniques are based on the ensemble autocorrelation function (ACF) produced by observation samples, which requires a large number of observations to perform accurate Doppler estimation. In still another part of the conventional techniques, an efficient maximum likelihood (ML) estimator is developed exploiting time correlations between frequency domain preamble signals of different symbols. Although this scheme achieves high estimation accuracy, it suffers from very high computational complexity.

Therefore, there is still a demand for a solution which can solve the aforementioned very high computational complexity problem of the conventional technique.

### SUMMARY OF THE INVENTION

To overcome the aforementioned very high computational complexity problem of the traditional Doppler spread estimator, the present invention provides a communication method for estimating Doppler spread.

The present invention discloses a communication method for estimating Doppler spread, including the following steps: transmitting a preamble signal to a receiver from a transmission terminal; receiving the preamble signal by the receiver; subsequently, dividing received samples in the preamble signal into a plurality of sets of samples; and introducing the plurality of sets of samples into a Doppler spread estimation algorithm to estimate Doppler spread.

One advantage of the present invention is that the present invention can effectively reduce the computational complexity of the Doppler spread estimator.

Another advantage of the present invention is that the present invention can provide more accurate Doppler spread estimation results than the conventional techniques when the Doppler spread estimator utilizes a maximum likelihood estimation method.

These and other advantages will become apparent from the following description of preferred embodiments taken together with the accompanying drawings and the appended claims.

### BRIEF DESCRIPTION OF THE DRAWINGS

The present invention may be understood by some preferred embodiments and detailed descriptions in the specification and the attached drawings below. The identical reference numbers in the drawings refer to the same components in the present invention. However, it should be appreciated that all the preferred embodiments of the invention are provided only for illustrating but not for limiting the scope of the Claims and wherein:

FIG. 1 illustrates the reordering of the samples within an OFDM symbol in accordance with one embodiment of the present invention;

FIG. 2 shows the normalized mean-square error (NMSE) performance of the preamble-based ML estimator based on the preamble signal designed in the present invention, denoted as ML-P, and that of the two conventional Doppler spread estimators in accordance with one embodiment of the present invention;

FIG. 3 shows the NMSE of the ML-P scheme corresponding to preamble signals with different sparsity factors P in accordance with one embodiment of the present invention;

FIG. 4 illustrates a flow chart of a communication method for estimating Doppler spread in accordance with one embodiment of the present invention;

FIG. 5 illustrates a diagram showing the way to form sets of samples in accordance with one embodiment of the present invention;

FIG. 6 illustrates a flow chart of a communication method for estimating Doppler spread in accordance with one embodiment of the present invention; and

FIG. 7 illustrates a block diagram of an exemplary mobile communication device cooperating with the communication method for estimating Doppler spread of the present invention in accordance with one embodiment of the present invention.

### DETAILED DESCRIPTION OF THE PREFERRED EMBODIMENT

The invention will now be described with the preferred embodiments and aspects and these descriptions interpret structure and procedures of the invention only for illustrating but not for limiting the Claims of the invention. Therefore, except the preferred embodiments in the specification, the present invention may also be widely used in other embodiments.

The present invention proposes an OFDM preamble signal and designs a time domain maximum likelihood (ML) Doppler spread estimation based on the received OFDM preamble signal. Furthermore, the received samples of the preamble signal may be divided into uncorrelated groups. This property allows a very low-complexity approach to attain the ML Doppler spread estimation.

Consider an OFDM system with N subcarriers and a total bandwidth B_{w}, where the sample duration of the time domain signal is Tₛ=1/B_{w} and the OFDM symbol duration is NTₛ. After the N-point inverse Discrete Fourier Transform (IDFT) of the mth frequency domain OFDM symbol, denoted as Xₘ[k] for 0≦k≦N−1, the time domain transmitted samples xₘ[n] is represented as

$${x}_{m} [ n ] = \frac{1}{\sqrt{N}} {\sum }_{k = 0}^{N - 1} {X}_{m} [ k ] {e}^{\frac{j 2 π nk}{N}} , \\ - {N}_{g} \leq n \leq N - 1 \qquad ( 1 )$$

The CP has a length of N_{g} samples, where N_{g} is chosen to be greater than the maximum channel length L. At the receiver, after removing the CP the received samples through a time-varying multipath channel is expressed as

$${y}_{m} [ n ] = {\sum }_{l = 0}^{L - 1} {h}_{l} [ n + m ( N + {N}_{g} ) ] {x}_{m} [ {( ( n - l ) )}_{N} ] + w [ n + m ( N + {N}_{g} ) ] , \\ 0 \leq n \leq N - 1 \qquad ( 2 )$$

where hₗ[n] is the time domain channel impulse response of the lth path and the nth sample, which approaches a zero mean complex Gaussian distribution in a common wireless transmission environment; and (( ))_{N} denotes the modulo N operation. In addition, w[n] is the complex-valued additive white Gaussian noise with variance σ_{w}².

In the common wireless environment, the wide-sense stationary uncorrelated scattering (WSSUS) model is commonly utilized to describe the transmission channels. In other words, hₗ[n] is assumed to be independent among different paths. By taking the isotropic scattering environment as an example, hₗ[n] possesses the correlation function given by

E{hₗ[n]h_{l′}[n+Δn]}=δ(l−l′)σₗ²J₀(2πƒ_{d}TₛΔn) (3)

where J₀( ) is the zero-order Bessel function of the first kind; ƒ_{d} is the maximum Doppler spread; δ( ) is the Dirac delta function; and σₗ² is the scattering power associated with the lth path. The present invention assumes that the total power of the channel is normalized such that Σₗ₌₀^{L-1}σₗ²=1.

Predetermined OFDM symbols, e.g. preamble symbols, are frequently used in OFDM systems to facilitate synchronization and channel estimation. Assume that an OFDM preamble signal consisting of M OFDM symbols is applied for Doppler spread estimation, and the nth time domain sample of the mth preamble symbol is denoted as x_{p,m}[n] where 0≦n≦N−1 and 0≦m≦M−1. Then, the mth preamble symbol is represented in vector form as x_{p,m}=[x_{p,m}[0], . . . ,x_{p,m}[N−1]]^{T}. After receiving the corrupted preamble signals, in one embodiment of the present invention, the CPs may be removed from the received corrupted preamble signals. In another embodiment of the present invention, the CPs removal procedure may be omitted. In the embodiment in which the CPs are removed from the received corrupted preamble signals, the received samples are expressed as yₚ=[y_{p,0}^{T},y_{p,1}^{T}, . . . , y_{p,M-1}^{T}]^{T}, where y_{p,m}=[y_{p,m}[0], . . . , y_{p,m}[N−1]]^{T}which is similar to equation (2). It should be noted that the length of yₚ is MN. With the knowledge of the transmitted signals x_{p,m}[n], the elements of yₚ are complex Gaussian random variables.

From equations (2) and (3), the covariance matrix of yₚ with size MN×MN is expressed by

$$C ( {f}_{d} ) = [ \begin{matrix}{C}_{0 , 0} & {C}_{0 , 1} & {C}_{0 , M - 1} \\ {C}_{1 , 0} & {C}_{1 , 1} & \\ {C}_{M - 1 , 0} & & {C}_{M - 1 , M - 1}\end{matrix} ] \qquad ( 4 )$$

where Cₘ_{₁}_{,m}_{₂}=E[y_{p,m}_{₁}y_{p,m}_{₂}^{H}] for 0≦m₁, m₂≦M−1. The entries of Cₘ_{₁}_{,m}_{₂} are then derived as

$${[ {C}_{{m}_{1} , {m}_{2}} ]}_{i , j} = {J}_{0} ( 2 π {f}_{d} {T}_{s} ( ( i - j ) + ( {m}_{1} - {m}_{2} ) ( N + {N}_{g} ) ) ) \times {\sum }_{l = 0}^{L - 1} {σ}_{l}^{2} {x}_{p , {m}_{1}} [ {( ( i - l ) )}_{N} ] {x}_{p , {m}_{2}}^{*} [ {( ( j - l ) )}_{N} ] + {σ}_{w}^{2} δ ( ( i - j ) + ( {m}_{1} - {m}_{2} ) ( N + {N}_{g} ) ) , \\ 0 \leq i , j \leq N - 1 \qquad ( 5 )$$

The covariance matrix C(ƒ_{d}) is utilized to calculate the log-likelihood (LLH) function for a specific Doppler frequency ƒ_{d}, given by

L(ƒ_{d};yₚ)=log[det(C(ƒ_{d}))]+yₚ^{H}C⁻¹(ƒ_{d})yₚ (₆)

Based on the received signal yₚ of a preamble signal, the optimal time domain ML Doppler spread estimation is obtained by

$${\hat{f}}_{d , opt} = arg {min}_{{f}_{d}} L ( {f}_{d} ; {y}_{p} ) \qquad ( 7 )$$

The solution can be derived by means of some nonlinear optimization methods or regular testing.

The optimal ML Doppler estimator in equation (7) provides accurate and efficient estimation results. However, the increase of the DFT size N or the growth of the number of collected preamble symbols M dramatically increases the computational complexity of the optimal estimator. This is due to the complicated calculation of the determinant and the inverse of the covariance matrix C(ƒ_{d}) when evaluating the LLH function in equation (6). It is noted that the computational complexity of the both matrix operations is about O((MN)³).

To reduce the complexity of the optimal ML Doppler estimator, the present invention first adopts another ML scheme to substitute the optimal ML scheme in equation (7), which is given by

$${\hat{f}}_{d} = arg {min}_{{f}_{d}} {\sum }_{m = 0}^{m - 1} L ( {f}_{d} ; {y}_{p , m} ) \qquad ( 8 )$$

where L(ƒ_{d};y_{p,m}) is the LLH function corresponding to the mth observation symbol y_{p,m} and the N×N covariance matrix C_{m,m}. The ML estimator in equation (8) ignores the cross correlations between samples from different preamble symbols, and the evaluation of the sum of M LLH functions, each of which is with complexity about O(N³), is simpler than that of equation (7). However, for an OFDM system with a large DFT size N, the computation cost of L(ƒ_{d}; y_{p,m}) is still considerable. The present invention then aims to simplify the ML scheme via a properly designed time domain preamble signal.

In one embodiment, one of the notions of simplifying the LLH evaluation in equation (8) is to design a preamble signal x_{p,m} which makes the received sequence y_{p,m} to be divided into several uncorrelated sets of samples. As a result, the LLH function L(ƒ_{d}; y_{p,m}) based on y_{p,m} then equals to the sum of the individual LLHs related to those uncorrelated sets. Given a finite value of ƒ_{d} such that J₀(2πƒ_{d}Tₛ(i−j)) does not rapidly approaches zero as |i−j| increases, and with an arbitrary distribution of the scattering power {σₗ²}ₗ₌₀^{L-1}, the present invention can find an uncorrelated condition of samples of y_{p,m} according to equation (5).

Uncorrelated condition: the ith and the jth samples of y_{p,m} are uncorrelated, i.e.

E[y_{p,m}y_{p,m}^{H}]=0, if for 0≦l≦L−1, x_{p,m}[((i−l))_{N}]=0 or x_{p,m}[((j−l))_{N}]=0.

A sequence which meets the following sparse property is found to satisfy the uncorrelated condition:

Sparse property: At least L−1 zeros appear between any two nonzero samples of x_{p,m}.

It is observed that the transmitted sequence with this property is sparse enough to avoid inter-sample interference due to delay multipaths and thus yields resolvable time domain channel responses at a receiver.

Choosing an integer P such that P is a factor of N and P≧L, a time domain preamble symbol that conforms to the above property is proposed for low-complexity ML Doppler spread estimation. The time domain preamble symbol is given by

x_{p,m}=\sqrt{Eₛ}P [a₀e^{T}, a₁e^{T}, . . . , a_{N/P-1}e^{T}]^{T} (9)

where Eₛ is the symbol energy, P is a cyclic shift identity matrix of size N×N, e=[1,0, . . . ,0]^{T} denotes the P×1 vector with all of its elements zero except the first one being unity; moreover, the present invention limits the coefficient {aᵢ}ᵢ₌₀^{N/P-1} to the coefficient with the unit power constraint Σᵢ₌₀^{N/P-1}|aᵢ|²=1 so as to achieve energy normalization. The parameter P is the occurrence period of the nonzero samples in the preamble signal and is called as the sparsity factor hereinafter.

Denoting the N/P-point DFT of the sequence {aᵢ}ᵢ₌₀^{N/P-1} by a and the phase rotating diagonal matrix related to P by Ξ, the frequency domain sequence X_{p,m}{k} corresponding to the proposed preamble signal is then expressed as

$${[ {X}_{p , m} [ 0 ] , … , {X}_{p , m} [ N - 1 ] ]}^{T} = \sqrt{{E}_{s}} {Ξ [ {\underbrace{{α}^{T} , {α}^{T} , … , {α}^{T}}}_{P} ]}^{T}$$

To more clearly show the complexity reduction for the ML estimator based on the proposed preamble signal, the present invention considers a preamble signal with constant coefficients and no cyclic shift as a special case, i.e. considers a preamble signal with aᵢ=\sqrt{P/N}, 0≦i≦N/P−1 and P being the identity matrix as a special case. According to equation (5), the auto-covariance matrix C_{m,m} of the received sequence y_{p,m} then can be derived as

$${[ {C}_{m , m} ]}_{i , j} = \{ \begin{matrix}\frac{{E}_{s} P {σ}_{i mod P}^{2}}{N} {J}_{0} ( 2 π {f}_{d} {T}_{s} ( i - j ) ) + {σ}_{w}^{2} δ ( i - j ) , & \begin{matrix}if ( i - j ) mod P = 0 and \\ i mod P \leq L - 1\end{matrix} \\ {σ}_{w}^{2} δ ( i , j ) , & otherwise\end{matrix} \qquad ( 10 )$$

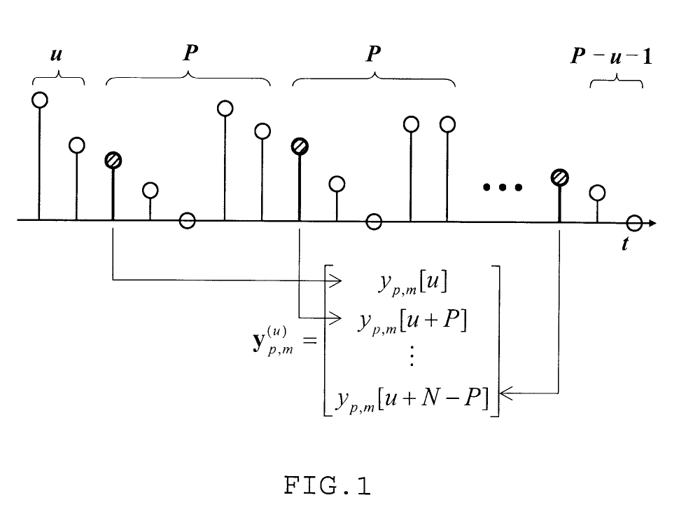

Collecting together the correlated samples of y_{p,m} yields a new observation sequence \tilde{y}_{p,m}=[(y_{p,m}⁽⁰⁾)^{T}, (y_{p,m}⁽¹⁾)^{T}, . . . ,(y_{p,m}^{(P-1)})^{T}]^{T}, where y_{p,m}^{(u)}=[y_{p,m}[u], y_{p,m}[u+P], . . . , y_{p,m}[u+N−P]]^{T} is a vector of length N/P, which is P-downsampled from y_{p,m} with the starting index u, u being an integer which is not less than 0. FIG. 1 illustrates the reordering of the samples within an OFDM symbol. It shall be noticed that the samples of \tilde{y}_{p,m} equivalently experience a flat fading channel because of using the sparse preamble signal. Thus, the values of {σₗ²}ₗ₌₀^{L-1} and σ_{w}² can be obtained via some well-known SNR estimation procedures over flat fading channels.

Permuting the rows and columns of C_{m,m} corresponding to \tilde{y}_{p,m}, then the covariance matrix of \tilde{y}_{p,m} is then given by

$${\tilde{C}}_{m , m} = [ \begin{matrix}{C}_{m , m}^{( 0 )} & {0}_{\frac{N}{P} \times \frac{N}{P}} & … & {0}_{\frac{N}{P} \times \frac{N}{P}} \\ {0}_{\frac{N}{P} \times \frac{N}{P}} & {C}_{m , m}^{( 1 )} & ⋱ & ⋮ \\ ⋮ & ⋱ & ⋱ & {0}_{\frac{N}{P} \times \frac{N}{P}} \\ {0}_{\frac{N}{P} \times \frac{N}{P}} & … & {0}_{\frac{N}{P} \times \frac{N}{P}} & {C}_{m , m}^{( P )}\end{matrix} ] \qquad ( 11 )$$

where [C_{m,m}^{(u)}]_{i,j}=[C_{m,m}]_{u+iP,u+jP}, and 0_{N/P×N/P} denotes the zero matrix of size (N/P)×(N/P). Because of the uncorrelated property between any two of the vectors of {yₚ^{(u)}}ᵤ₌₀^{P-1}the ML estimator in equation (8) can be rewritten as

$$\begin{matrix}{\hat{f}}_{d} = arg {min}_{{f}_{d}} {\sum }_{m = 0}^{M - 1} {\sum }_{u = 0}^{L - 1} L ( {f}_{d} ; {y}_{p , m}^{( u )} ) \\ where & ( 12 ) \\ L ( {f}_{d} ; {y}_{p , m}^{( u )} ) = log [ det ( {C}_{m , m}^{( u )} ) ] + {( {y}_{p , m}^{( u )} )}^{H} {( {C}_{m , m}^{( u )} )}^{- 1} {y}_{p , m} & ( 13 )\end{matrix}$$

It is noted that since for P≧L, {C_{m,m}^{(u)}}_{u=L}^{P-1} are equal to σ_{w}²I_{N/P×N/P}, the upper limit of the inner summation of equation (12) is L−1 rather than P−1. Exploiting the proposed preamble signal, the complexity of the calculation of L(ƒ_{d};y_{p,m}) then decreases from about O(N³) to O((N/P)³), which is inversely proportional to P³.

The present invention performs simulations for the proposed low-complexity ML Doppler spread estimator. In the simulations, the present invention employs an OFDM system with subcarrier spacing 10 kHz. The total number of subcarriers is set to be N=256 or 1024, and the CP length is N_{g}=32. The number of the preamble symbols for Doppler spread estimation is M=30, corresponding to an observation duration smaller than 3.5 ms. It is assumed that the information of the channel's scattering power and the noise power, i.e. {σₗ²}ₗ₌₀^{L-1} and σ_{w}², is given by means of some SNR and channel estimation techniques. The present invention further defines the symbol-level SNR as γ=Eₛ/Nσ_{w}² and the NMSE as

$$NMSE = \frac{MSE}{{f}_{d}^{2}} = \frac{E \{ {\vert {\hat{f}}_{d} - {f}_{d} \vert}^{2} \}}{{f}_{d}^{2}} \qquad ( 14 )$$

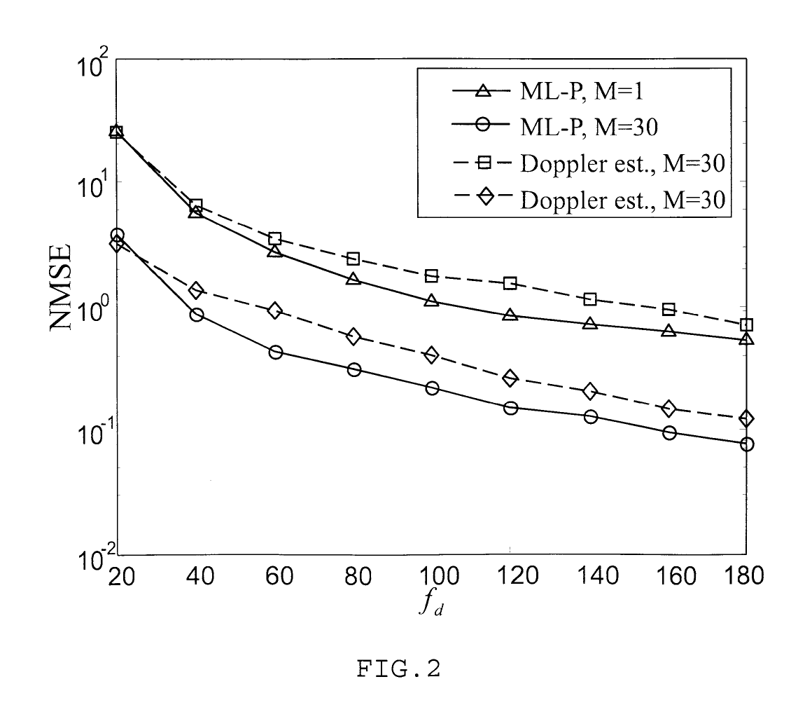

FIG. 2 shows the NMSE performance of the ML estimator proposed in the present invention (ML-P) based on the preamble signal designed in the present invention and that of the two conventional Doppler spread estimators. In this simulation, the DFT size is N=1024 and the SNR is 5 dB. The Doppler spread ƒ_{d} ranges from 20 to 180 Hz, corresponding to a typical velocity region in an urban area from 0 to 97.2 km/hr at 2 GHz band. The multipath channel is generated based on the ITU Vehicular-A Channel model. FIG. 2 also illustrates the NMSE of the ML estimator scheme based on one preamble symbol, i.e. M=1, equivalent to a very short observation interval within 0.1 ms. Comparing to the conventional Doppler estimator, it is found in FIG. 2 that due to higher estimation efficiency of the ML-based criterion, the proposed estimator scheme can obtain more accurate Doppler spread estimation results than the conventional estimator except for ƒ_{d}<30 Hz. In addition, the ML-P method achieves better NMSE than the conventional estimator but utilizes only 1/30 of the observation duration exploited by the conventional estimator. This means that under the same performance requirement, the estimation delay of the proposed Doppler spread estimator is much shorter than that of the conventional estimator.

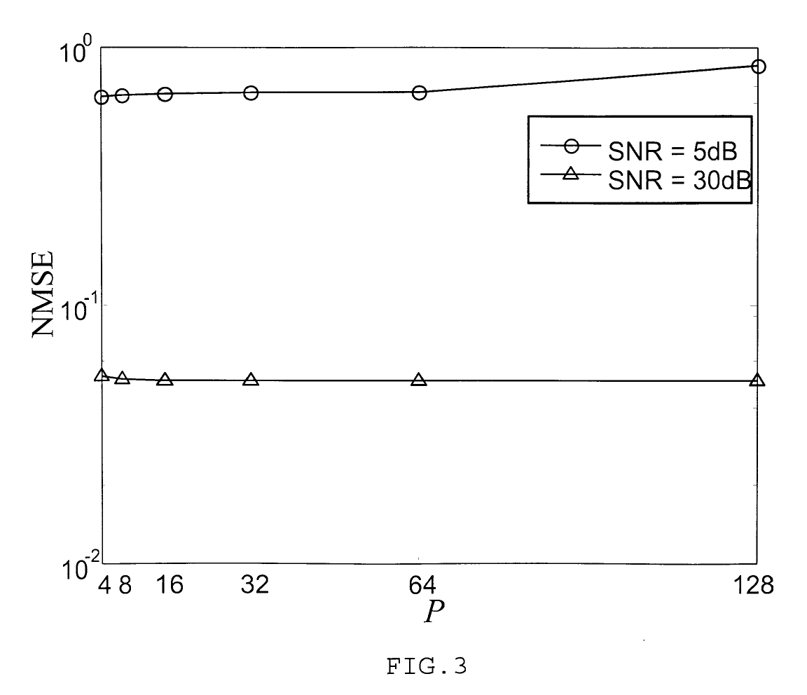

FIG. 3 shows the NMSE of the ML-P scheme corresponding to preamble signals with different P for γ=5 dB and 30 dB, and Doppler frequency ƒ_{d}=100 Hz. The DFT size of this simulation is N=256. The present invention adopts a uniform delay profile with the scattering power per path equal to 1/L to generate the multipath channel, where the unit delay time is Tₛ and the channel length is L=3. The simulation results show that for the case with γ=5 dB, the ML-P schemes using the preamble signals with P=4, 8, 16, 32, 64 yield almost the same NMSE performance. But for P=128, it is found that the NMSE performance degrades due to not enough observation samples per symbol for Doppler spread estimation in low SNR environments. For this case the present invention can conclude that P=64 is an preferred sparsity factor for the ML-P scheme due to a larger complexity reduction with almost no compromise in performance. However, in a high-SNR region, e.g. 30 dB, the ML-P scheme based on the preamble signal with P=128 attains almost the same performance as that in all other cases, such that the P=128 becomes the preferred choice. It should be noted that when choosing P=64 and 128, the ML-P estimator only deals with the determinant and the inverse of a 4×4 and a 2×2 matrix, respectively.

In one embodiment of the present invention, the present invention provides the preamble-based ML Doppler spread estimation in OFDM systems. Considering the high computation cost of the optimal ML estimator, the present invention proposes a sparse OFDM preamble signal for complexity reduction. The preamble signal of the present invention allows the corresponding received samples to be able to be divided into uncorrelated subsets, such that a low-complexity ML estimator, the ML-P approach, can be further developed. In the simulation, comparing to the conventional Doppler spread estimators, the proposed method attains better NMSE performance; in other words, the estimation method of the present invention can achieve the required performance by using fewer observations. Moreover, via properly selecting the sparsity factor of the preamble symbol, the complexity of the ML-P estimator can be substantially decreased with almost no loss in performance.

The present invention may include various processes. The processes of the present invention may be performed by hardware components or software components which may be used to cause a general purpose or special purpose microprocessor or logic circuits programmed with the instructions to perform the processes.

Alternatively, the processes may be performed by a combination of hardware and software.

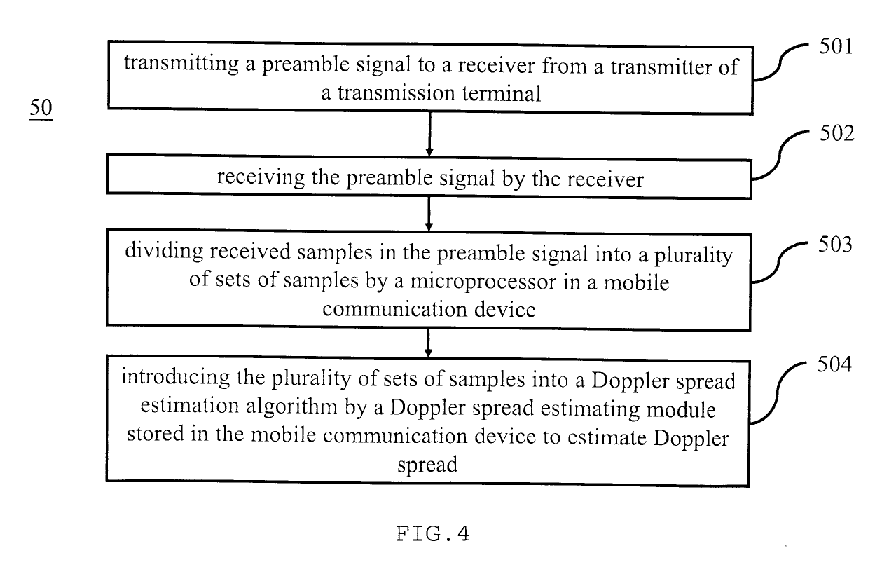

In one embodiment of the present invention, as shown in FIG. 4, the present invention provides a communication method for estimating Doppler spread. The communication method for estimating Doppler spread 50 of the present invention includes transmitting a preamble signal to a receiver from a transmitter of a transmission terminal in step 501. In one embodiment, P−1 zeros may be included between any two nonzero samples of the transmitted preamble signal. In one embodiment of the present invention, P may be a positive integer. In another embodiment of the present invention, P may be a positive integer greater than or equal to the maximum channel length L. Subsequently, the preamble signal is received by the receiver in step 502. Then, received samples in the preamble signal are divided into a plurality of sets of samples by a microprocessor in a communication device, for example a mobile communication device, in step 503. Subsequently, the plurality of sets of samples are introduced into a Doppler spread estimation algorithm by a

Doppler spread estimation module stored in the communication device, for example the mobile communication device, to estimate Doppler spread in step 504. In one embodiment, the Doppler spread estimation algorithm may be preamble-based maximum likelihood (ML) estimation algorithm or any other Doppler spread estimation processes or estimators. When the Doppler spread estimation algorithm is the preamble-based maximum likelihood (ML) estimation algorithm, a total log-likelihood result of the plurality of sets of samples is introduced into the preamble-based ML estimation algorithm. In one embodiment, the plurality of sets of samples may be uncorrelated with one another. In one embodiment, the preamble-based ML estimation algorithm may be

$${\hat{f}}_{d} = arg {min}_{{f}_{d}} {\sum }_{m = 0}^{M - 1} {\sum }_{u = 0}^{L - 1} L ( {f}_{d} ; {y}_{p , m}^{( u )} ) .$$

It shall be noted that the present invention may also be applied to any kinds of Doppler spread estimators or estimation methods in addition to the preamble-based ML estimation algorithm. The present invention may effectively decrease the computational complexity of the Doppler spread estimator or estimation algorithm by dividing the received samples in the preamble signal into a plurality of sets of samples and further introducing the plurality of sets of samples into a Doppler spread estimation algorithm respectively. The present invention can provide more accurate Doppler spread estimation results when the Doppler spread estimator utilizes a maximum likelihood estimation method such as the preamble-based ML estimation algorithm.

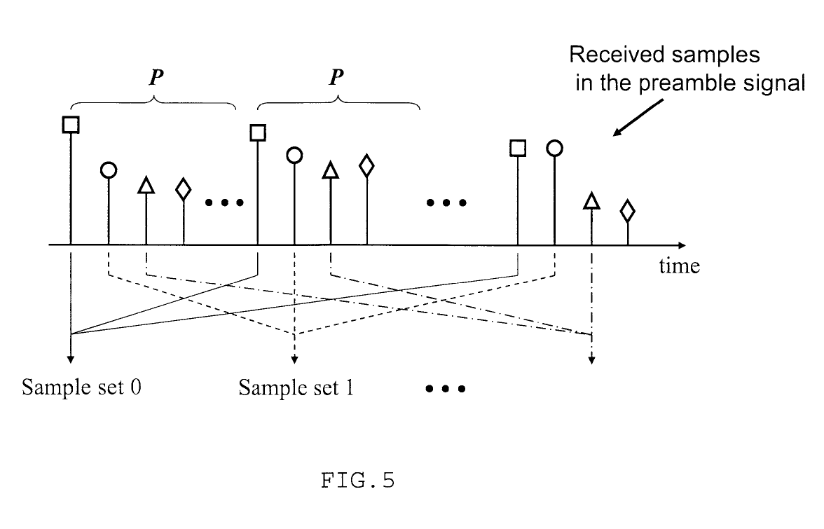

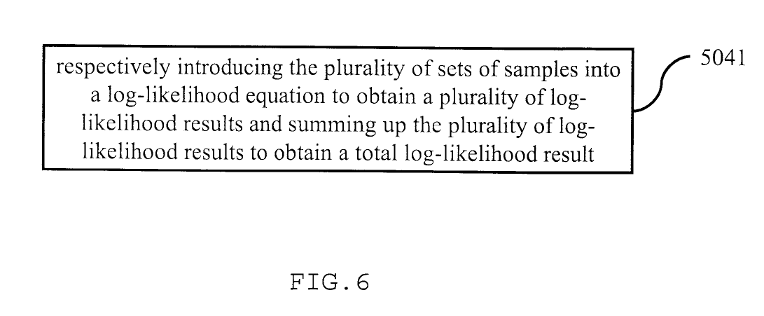

In one embodiment, as shown in FIG. 5, each sample set of the plurality of sets of samples is acquired from the received samples of the preamble signal in an equally-spaced way. In one embodiment of the present invention, each sample set may include at least two samples acquired from the received samples of the preamble signal. In one embodiment of the present invention, the size of the space is optionally the number of samples which may be a positive integer. In another embodiment of the present invention, the size of the space is optionally the number of samples which may be a positive integer greater than or equal to the maximum channel length (L). As shown in FIG. 5, P is the number of spaced samples, wherein P is greater than or equal to the maximum channel length (L). In one embodiment of the present invention, the parameter P herein may be equal to the parameter P in connection with the number of zeros included between any two nonzero samples of the transmitted preamble signal. In one embodiment, as shown in FIG. 6, when the Doppler spread estimation algorithm is the preamble-based maximum likelihood (ML) estimation algorithm, a step 5041 may be further included before the step 504. The plurality of sets of samples are respectively introduced into a log-likelihood equation to obtain a plurality of log-likelihood results and then the plurality of log-likelihood results are further summed up to obtain a total log-likelihood result in step 5041. In one embodiment, the log-likelihood equation may be

L(ƒ_{d}; y_{p,m}^{(u)})=log[det(C_{m,m}^{(u)})]+(y_{p,m}^{(u)})^{H} (C_{m,m}^{(u)})⁻¹y_{p,m}.

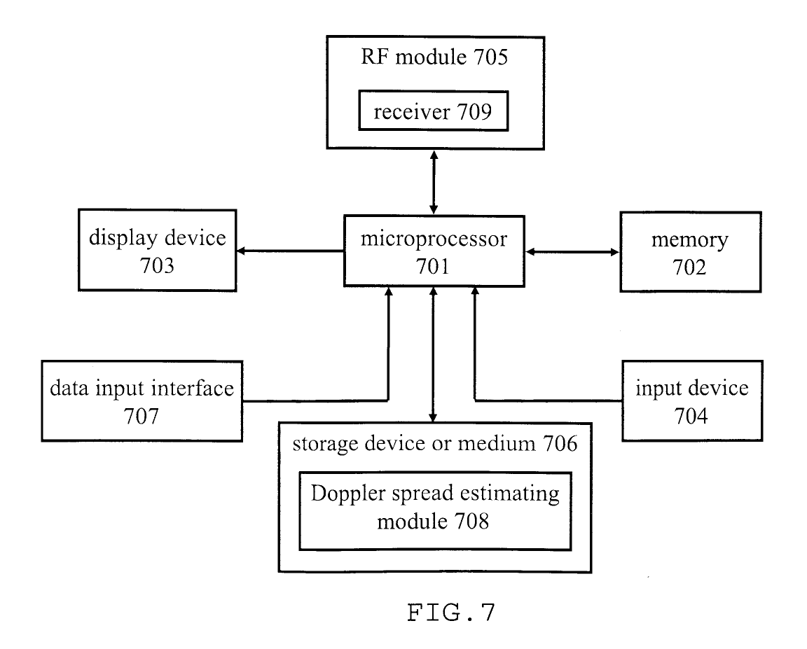

With reference to FIG. 7, the Doppler spread estimation module 708 provided in the present invention is stored in a storage device or medium 706 of a mobile communication device in FIG. 7. The Doppler spread estimation may be implemented by the cooperation of the microprocessor 701 with other components. Portions of the present invention may be provided as a program product, which may include an information storage medium having stored thereon program instructions, which may be used to program a microprocessor (or other electronic devices) to perform a process according to the present invention. The information storage medium may include, but is not limited to, chips, ROMs (read only memory), RAMs (random access memory), EPROMs (erasable programmable read-only memory), EEPROMs (electrically erasable programmable read-only memory), flash memory, or other type of information storage medium suitable for storing electronic instructions.

To achieve the objects of the present invention, the communication method for estimating Doppler spread of the present invention may cooperate with the mobile communication device exemplarily shown in FIG. 7 to perform or execute related instructions. The mobile communication device is shown for illustrating the present invention, not for limiting the present invention. As shown in FIG. 7, the mobile communication device includes a microprocessor 701, a memory 702 electrically coupled to the microprocessor 701, and a display device 703 electrically coupled to the microprocessor 701 to display information. An input device 704 is electrically coupled to the microprocessor 701 to input instructions. For example, the input device 704 may include a keypad or a touch module. A RF(radio frequency) module 705 is electrically coupled to the microprocessor 701. A storage device or medium 706, which may include chip, ROM, RAM, EPROM, EEPROM, flash memory or nonvolatile memory, is electrically coupled to the microprocessor 701. In one embodiment, the storage device or medium 706 may store the Doppler spread estimation module 708 to estimate Doppler spread. A data input interface 707, which may include a wired data input interface and a wireless data input interface, is electrically coupled to the microprocessor 701. The wired data input interface may include universal serial bus. The wireless data input interface may include BLUETOOTH and IR (infrared). The RF module 705 of the mobile communication device may further include a receiver 709 to receive the preamble signal from the transmission terminal.

The foregoing description is a preferred embodiment of the present invention. It should be appreciated that this embodiment is described for purposes of illustration only, not for limiting, and that numerous alterations and modifications may be practiced by those skilled in the art without departing from the spirit and scope of the invention. It is intended that all such modifications and alterations are included insofar as they come within the scope of the invention as claimed or the equivalents thereof.

What is claimed is:

1. A communication method for estimating Doppler spread, comprising:
transmitting a preamble signal to a receiver from a transmitter;
receiving said preamble signal by said receiver;
dividing received samples in said preamble signal into a plurality of sets of samples; and
introducing said plurality of sets of samples into a Doppler spread estimation algorithm to estimate Doppler spread.

2. The method of claim 1, wherein said Doppler spread estimation algorithm comprises a preamble-based maximum likelihood estimation algorithm, and the step of introducing said plurality of sets of samples into a Doppler spread estimation algorithm comprises introducing a total log-likelihood result of said plurality of sets of samples into said Doppler spread estimation algorithm.

3. The method of claim 2, before the step of introducing a total log-likelihood result of said plurality of sets of samples into said preamble-based maximum likelihood estimation algorithm, further comprising:
respectively introducing said plurality of sets of samples into a log-likelihood equation to obtain a plurality of log-likelihood results and summing up said plurality of log-likelihood results to obtain said total log-likelihood result.

4. The method of claim 3, wherein said log-likelihood equation is
L(ƒ_{d}; y_{p,m}^{(u)})=log[det(C_{m,m}^{(u)})]+(y_{p,m}^{(u)})^{H} (C_{m,m}^{(u)})⁻¹y_{p,m},
wherein ƒ_{d} denotes maximum Doppler spread, u denotes starting index and is an integer which is not less than 0, y_{p,m} denotes partial samples in said received samples in said preamble signal corresponding to an mth symbol, and C_{m,m} denotes auto-covariance matrix of said partial samples in said received samples corresponding to said mth symbol.

5. The method of claim 2, wherein said preamble-based maximum likelihood estimation algorithm is
$${\hat{f}}_{d} = arg {min}_{{f}_{d}} {\sum }_{m = 0}^{M - 1} {\sum }_{u = 0}^{L - 1} L ( {f}_{d} ; {y}_{p , m}^{( u )} ) ,$$
wherein ƒ_{d} denotes maximum Doppler spread, u denotes starting index and is an integer which is not less than 0, y_{p,m} denotes partial samples in said received samples in said preamble signal corresponding to an mth symbol, M denotes number of samples of said received samples, L denotes maximum channel length, and L(•;•) denotes log-likelihood equation.

6. The method of claim 1, wherein the step of dividing received samples in said preamble signal into a plurality of sets of samples comprises:
acquiring uth sample in said received samples of said preamble signal as 1st sample in uth set of samples; and
acquiring u+Pth sample, u+2Pth sample to u+NPth sample in said received samples of said preamble signal in order until all said received samples of said preamble signal to complete said uth set of samples, wherein P is a positive integer, u is an integer which is not less than 0, and N is an integer greater than 2.

7. The method of claim 1, wherein the step of dividing received samples in said preamble signal into a plurality of sets of samples comprises:
acquiring uth sample in said received samples of said preamble signal as 1st sample in uth set of samples; and
acquiring u+Pth sample and u+2Pth sample in said received samples of said preamble signal in order to complete said uth set of samples, wherein P is a positive integer and u is an integer which is not less than 0.

8. The method of claim 1, wherein the step of dividing received samples in said preamble signal into a plurality of sets of samples comprises:
acquiring uth sample in said received samples of said preamble signal as 1st sample in uth set of samples; and
acquiring u+Pth sample in said received samples of said preamble signal to complete said uth set of samples, wherein P is a positive integer and u is an integer which is not less than 0.

9. The method of claim 1, wherein P−1 zeros are included between any two nonzero samples of said transmitted preamble signal, wherein P is a positive integer.
